(19) United States
(12) Patent Application Publication
(10) Pub. No.: US 2016/0024767 A1
(43) Pub. Date: Jan. 28, 2016

(54) SENSOR FAUCET AND INFRARED SENSOR THEREOF

(71) Applicant: GLOBE UNION INDUSTRIAL CORP., TAICHUNG CITY (TW)

(72) Inventors: CHU-WAN HONG, TAICHUNG CITY (TW); HSUAN-TSUNG CHEN, TAICHUNG CITY (TW); ZHI-MING HSU, TAICHUNG CITY (TW)

(73) Assignee: GLOBE UNION INDUSTRIAL CORP., TAICHUNG CITY (TW)

(21) Appl. No.: 14/804,200

(22) Filed: Jul. 20, 2015

(30) Foreign Application Priority Data
Jul. 25, 2014 (CN) 201410359054.7

(51) Int. Cl. E03C 1/05; G02B 5/20; G01S 17/02

(52) U.S. Cl. CPC E03C 1/057; G01S 17/026; G02B 5/208

(57) ABSTRACT

An infrared sensor includes a first emitting module, a second emitting module, and a receiving module. The first emitting module includes a first emitter and a first lens; the second emitting module includes a second emitter and a second lens. The first emitter and the second emitter respectively emit an infrared ray along an optical axis, wherein an acute angle is formed between the optical axes. The receiving module is located between the first emitting module and the second emitting module, wherein the receiving module includes a receiver and a third lens. The infrared rays emitted from the first and the second emitter respectively pass through the first and the second lens, afterwards, the infrared rays are reflected to pass through the third lens, and thus received by the receiver. Additionally, the infrared sensor may be applied to a sensor faucet for controlling a water valve in the sensor faucet.

### BACKGROUND OF THE INVENTION

1. Technical Field

The present invention relates generally to a sanitary apparatus, and more particularly to a sensor faucet and an infrared sensor thereof.

2. Description of Related Art

In comparison with a conventional faucet of which water valve has to be manually operated, a touchless faucet is convenient, clean, and capable of reducing the chances of spreading diseases which may be caused due to microbes thriving on faucet handles. Therefore, sensor faucets are commonly provided in many public areas, such as restaurants, hospitals, and public toilets.

Conventionally, a sensor faucet includes an infrared sensor which consists of an infrared emitter and an infrared receiver. The infrared emitter emits an infrared ray to generate a sensing area. When hands of a user enter the sensing area, the infrared ray emitted from the infrared emitter is reflected by the hands, and then the reflected infrared ray is received by the infrared receiver. Accordingly, the infrared receiver closes an electrical circuit to open the water valve in the sensor faucet. On the other hand, when hands of a user move away from the sensing area, the water valve is in a closed state without being triggered by the reflected infrared ray. However, a common infrared sensor only includes one single infrared emitter which generates a small sensing area. In such case, the sensing area are usually too small for users to precisely estimate how close to the faucet his/her hands should be, which causes a fitful water flow, and thus brings inconvenience to users.

In addition, the infrared emitter usually includes an LED as a radiation source. The LED increases the emitting angle and the extraction efficiency of the infrared ray with primary optical design. However, while increasing the emitting angle of the infrared ray to broaden the sensing area, the sensing distance in response to objects would be shortened. Hence, the infrared ray is not intense enough to be efficiently received by the infrared receiver. To solve this problem, the infrared receiver has to further include a signal amplification circuit to amplify the received infrared ray for controlling the water valve effectively. As a result, the manufacturing cost of such an infrared receiver would be high.

### BRIEF SUMMARY OF THE INVENTION

In view of the above, the primary objective of the present invention is to provide an infrared sensor and a sensor faucet with the infrared sensor, which has a low manufacturing cost, small size, and is capable of generating a large sensing area.

The present invention provides an infrared sensor, which includes a first emitting module, a second emitting module, and a receiving module. The first emitting module includes a first emitter and a first lens with positive refractive power, wherein the first emitter emits an infrared ray along a first optical axis which passes through the first lens. The second emitting module includes a second emitter and a second lens with positive refractive power, wherein the second emitter emits an infrared ray along a second optical axis which passes through the second lens. The first optical axis and the second optical axis are non-parallel, and an acute angle is formed therebetween. The receiving module is located between the first emitting module and the second emitting module for receiving the infrared ray emitted by the first emitting module or the second emitting module after the infrared ray being reflected by an object.

The present invention further provides sensor faucet, which includes a water pipe which has an outlet, and an infrared sensor. The infrared sensor emits two infrared rays, and receives two reflected infrared rays after the two infrared rays being reflected by an object. An acute angle is formed between two optical axes of the two infrared rays. The two infrared rays generate a sensing area which covers a region under the outlet.

The infrared sensor of the present invention can broaden the sensing area through the two non-parallel optical axes. Moreover, the positive refractive power of the first, the second, and the third lens is helpful to effectively increase the intensity of the infrared rays. Therefore, the infrared rays are increased to be efficiently received by the receiver without the need of an additional signal amplification circuit. In this way, the manufacturing cost of the infrared sensor may be lowered, and the size of the infrared sensor may be reduced as well.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a schematic diagram of a preferred embodiment of the present invention, showing the infrared sensor; and

FIG. 2 is a schematic diagram of the preferred embodiment of the present invention, showing the sensor faucet.

### DETAILED DESCRIPTION OF THE INVENTION

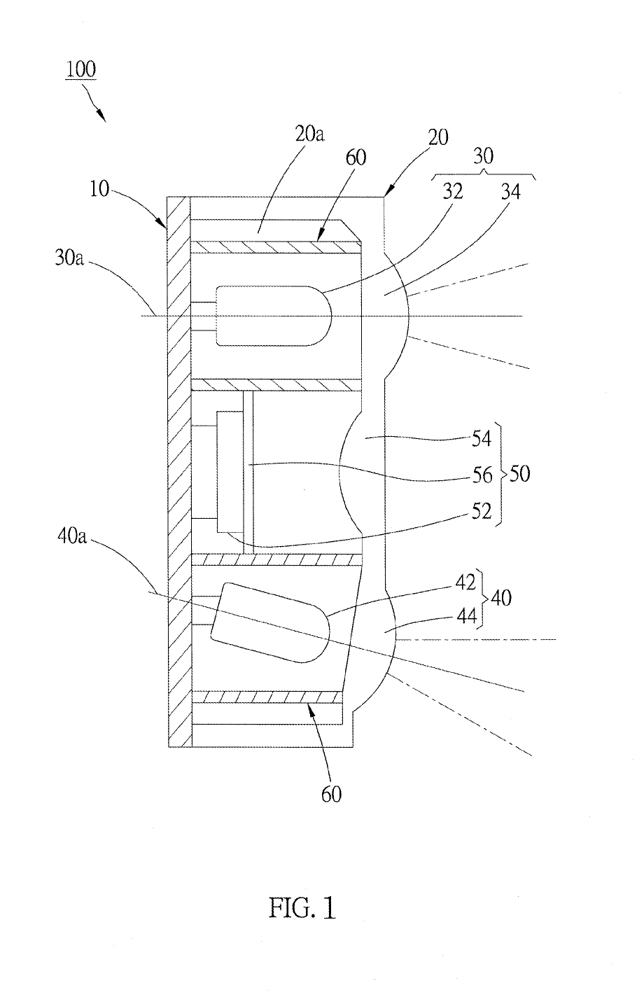

As shown in FIG. 1, an infrared sensor 100 of the preferred embodiment of the present invention includes a circuit board 10, a casing 20, a first emitting module 30, a second emitting module 40, a receiving module 50, and shielding members consisting of two light shields 60. The circuit board 10 and the casing 20 are detachably connected to form a containing space 20a. The first emitting module 30, the second emitting module 40, the receiving module 50 and the two light shields 60 are received in the containing space 20a.

The first emitting module 30 includes a first emitter 32 and a first lens 34 with positive refractive power. The first emitter 32 is provided on the circuit board 10 to emit an infrared ray having specific wavelengths, wherein the infrared ray travels along a first optical axis 30a. The first lens 34 is integrally provided on the casing 20, and the first optical axis 30a passes through a curvature center of the first lens 34.

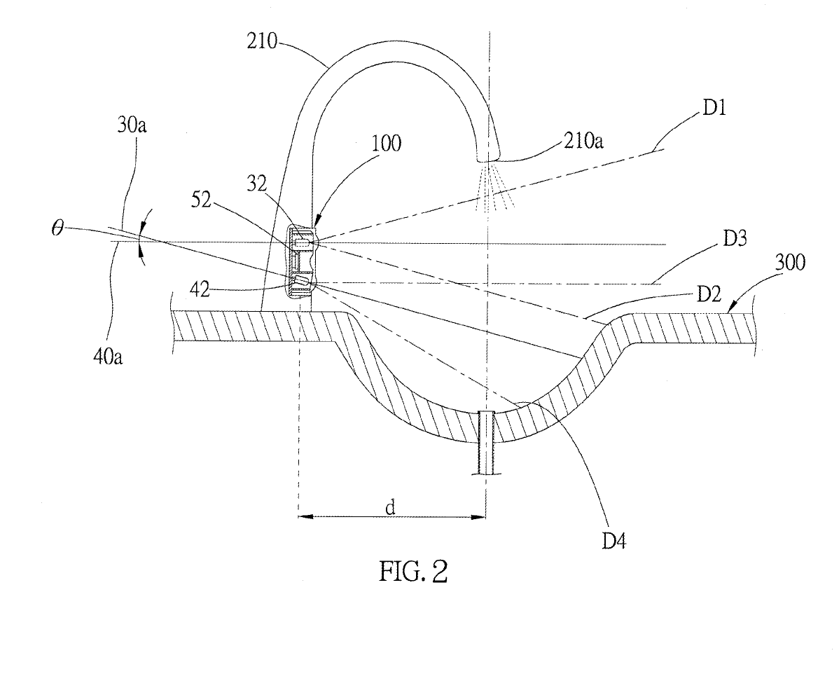

The second emitting module 40 includes a second emitter 42 and a second lens 44 with positive refractive power. The second emitter 42 is provided on the circuit board 10 to emit an infrared ray having specific wavelengths, wherein the infrared ray travels along a second optical axis 40a. The second lens 44 is integrally provided on the casing 20, and the second optical axis 40a passes through a curvature center of the second lens 44. The distance between the first emitter 32 and the second emitter 42 is greater than or equal to 2 centimeters. Moreover, the emission direction of the infrared ray emitted by the first emitter 32 is vertical to a surface of the circuit board 10, while the emission direction of the infrared ray emitted by the second emitter 42 is not vertical to the surface of the circuit board 10. Therefore, an acute angle θ is formed between the first optical axis 30a and the second optical axis 40a (as shown in FIG. 2). In the preferred embodiment, the acute angle is between 15 to 40 degrees.

The receiving module 50 is located between the first emitting module 30 and the second emitting module 40. In addition, the receiving module 50 includes a receiver 52, a third lens 54 with positive refractive power, and a filter 56. The receiver 52 is provided on the circuit board 10; the third lens 54 is integrally provided on the casing 20, and is corresponding to the receiver 52. The filter 56 is provided on the receiver 52, and is located between the receiver 52 and the third lens 54 for filtering out infrared rays which have wavelengths other than the specific wavelengths of the infrared rays emitted by the first emitter 32 and the second emitter 42. After the infrared rays are reflected by an object, the reflected infrared rays have to pass through the third lens 54 and the filter 56 before being received by the receiver 52. In other words, the filter 56 is able to ensure that the receiver 52 only receives the infrared ray having specific wavelengths without being interfered by infrared rays having wavelengths other than the specific wavelengths. In this way, the sensing accuracy of the infrared sensor 100 can be improved.

The two light shields 60 are two barrels which are put around the first emitter 32 and the second emitter 42 respectively for preventing the infrared rays which are emitted from the first and the second emitter 32, 42 but never passing through the first and the second lens 34, 44 from being received by the receiver 52; whereby, the accuracy of the receiver 52 for receiving the reflected infrared rays can be further enhanced to avoid false detection.

In the preferred embodiment abovementioned, the first, the second, and the third lenses 34, 44, 54 are convex lenses respectively provided on the casing 20, but this is not a limitation of the present invention. For example, the first, the second, or the third lenses 34, 44, 54 may consist of a plurality of convex lenses and concave lenses for intensifying optical effects. Through such a secondary optics design, the positive refractive power of the lenses may be increased to be helpful for more efficiently focusing the infrared rays, raising the intensity of the infrared rays emitted from the first and the second emitters 32, 42, and accordingly increasing the intensity of the infrared rays to be received by the receiver 52.

As shown in FIG. 2, the infrared sensor 100 is applied to a sensor faucet, wherein the sensor faucet includes a gooseneck-shaped water pipe 210 which is connected to a sink 300; the infrared sensor 100 is fixed to the water pipe 210, and is electrically connected to a water valve (not shown) which controls water flow.

An area between a dotted line D1 and a dotted line D2 in FIG. 2 is defined as a sensing area formed by the infrared ray emitted from the first emitter 32; an area between a dotted line D3 and a dotted line D4 is defined as a sensing area generated by the infrared ray emitted from the second emitter 42. The sensing areas cover the region under an outlet 210a of the water pipe 210. Hence, when hands of a user enter the sensing areas and reflect the infrared rays, the reflected infrared rays is thus received by the receiver 52, which triggers the opening of the water valve to further cause water to flow out from the water pipe 210. On the other hand, when hands of a user are moved away from the sensing areas, the water valve is in a closed state without being triggered by the reflected infrared rays, and no water flow is generated from the water pipe 210. In this way, controlling the water flow by the infrared sensor 100 may save energy.

In addition, the infrared sensor 100 adjusts the coverage region of the sensing areas when a horizontal distance d between the infrared sensor 100 and the outlet 210a changes according to different types of sensor faucets. The adjusting ways are included below:
(1) adjusting the distance between the first emitter 32 and the second emitter 42, wherein the longer the distance, the broader the sensing areas;
(2) adjusting the acute angle θ formed between the first optical axis 30a and the second optical axis 40a, wherein the greater the acute angle θ, the broader the sensing areas;
(3) adjusting the positive refractive power of the lenses, wherein increasing the positive refractive power makes the infrared ray further focused, which is helpful to increase the intensity of the infrared rays and the distance of the infrared rays responsive to objects, while reducing the positive refractive power makes the sensing areas broader.

In conclusion, the infrared sensor 100 broadens the sensing areas due to the non-parallel optical axes 30a and 40a. Moreover, the positive refractive power of the first, the second, and the third lenses 34, 44, 54 is helpful to effectively increase the intensity of the infrared rays emitted from the first emitter 30 and the second emitter 40. As a result, the emitted infrared rays are intensive enough to be received by the receiver 52 without the need of an additional signal amplification circuit. In this way, the amount of electronic components on the circuit board 10 are decreased so as to increase the stability of the electrical circuits, lower the manufacturing cost of the receiver 52, and to reduce the size of the infrared sensor 100.

It must be pointed out that the embodiments described above are only some preferred embodiments of the present invention. All equivalent structures which employ the concepts disclosed in this specification and the appended claims should fall within the scope of the present invention.

What is claimed is:

1. An infrared sensor comprising:
a first emitting module, which comprises a first emitter and a first lens with positive refractive power, wherein the first emitter emits an infrared ray along a first optical axis which passes through the first lens;
a second emitting module, which comprises a second emitter and a second lens with positive refractive power, wherein the second emitter emits an infrared ray along a second optical axis which passes through the second lens; the first optical axis and the second optical axis are non-parallel, and an acute angle is formed therebetween; and
a receiving module, which is located between the first emitting module and the second emitting module for receiving the infrared rays emitted by the first emitting module and the second emitting module after the infrared rays being reflected by an object.

2. The infrared sensor of claim 1, wherein the receiving module comprises a receiver and a third lens with positive refractive power; the receiver receives the reflected infrared rays after the reflected infrared rays passing through the third lens.

3. The infrared sensor of claim 1, wherein the acute angle is between 15 to 40 degrees.

4. The infrared sensor of claim 1, wherein a distance between the first emitter and the second emitter is greater than or equal to 2 centimeters.

5. The infrared sensor of claim 2, further comprising a filter located between the receiver and the third lens; the infrared rays emitted from the first emitter and the second emitter haves specific wavelengths, wherein the filter filters out infrared rays which have wavelengths other than the specific wavelengths.

6. The infrared sensor of claim 2, further comprising a casing, wherein the first lens, the second lens, and the third lens are integrally provided on the casing; the first emitter, the second emitter, and the receiver are received inside the casing.

7. The infrared sensor of claim 1, further comprising at least one shielding member, which prevents the infrared rays which are emitted from the first emitter and the second emitter but never passing through the first lens and the second lens from being received by the receiver.

8. The infrared sensor of claim 2, wherein the acute angle is between 15 to 40 degrees.

9. The infrared sensor of claim 2, wherein a distance between the first emitter and the second emitter is greater than or equal to 2 centimeters.

10. The infrared sensor of claim 2, further comprising at least one shielding member, which prevents the infrared rays which are emitted from the first emitter and the second emitter but never passing through the first lens and the second lens from being received by the receiver.

11. A sensor faucet, comprising:
a water pipe, which has an outlet; and
an infrared sensor, which emits two infrared rays, and receives the two infrared rays after the two infrared rays being reflected by an object; an acute angle is formed between two optical axes of the two infrared rays; the two infrared rays generate a sensing area which covers a region under the outlet.

12. The sensor faucet of claim 11, wherein the infrared sensor comprises:
a first lens with positive refractive power;
a first emitter, which emits one of the infrared rays along a first optical axis, which passes through the first lens;
a second lens with positive refractive power;
a second emitter, which emits the other one of the infrared rays along a second optical axis, which passes through the second lens; the acute angle is formed between the first optical axis and the second optical axis;
a receiver provided between the first emitter and the second emitter to receive the two infrared rays after the two infrared rays being reflected.

13. The sensor faucet of claim 12, wherein the infrared sensor comprises a third lens; the receiver receives the two reflected infrared rays after the two reflected infrared rays passing through the third lens.

14. The sensor faucet of claim 13, wherein the infrared sensor comprises a filter located between the receiver and the third lens; the two infrared rays emitted from the first emitter and the second emitter have specific wavelengths, wherein the filter filters out infrared rays having wavelengths other than the specific wavelengths.

15. The sensor faucet of claim 13, wherein the infrared sensor comprises a casing; the first lens, the second lens, and the third lens are integrally provided on the casing; the first emitter, the second emitter, and the receiver are received inside the casing.

16. The sensor faucet of claim 12, wherein a distance between the first emitter and the second emitter is greater than or equal to 2 centimeters.

17. The sensor faucet of claim 12, wherein the infrared sensor comprises at least one shielding member, which prevents the two infrared rays which are emitted from the first emitter and the second emitter but never passing through the first lens and the second lens from being received by the receiver.
